(19) United States
(12) Patent Application Publication
(10) Pub. No.: US 2015/0047878 A1
(43) Pub. Date: Feb. 19, 2015

(54) ELECTROCONDUCTIVE PARTICLE, CIRCUIT CONNECTING MATERIAL, MOUNTING BODY, AND METHOD FOR MANUFACTURING MOUNTING BODY

(71) Applicant: DEXERIALS CORPORATION, Tokyo (JP)

(72) Inventors: Takeshi Tamaki, Tochigi (JP); Yoshito Tanaka, Tochigi (JP)

(21) Appl. No.: 14/386,707

(22) PCT Filed: Mar. 22, 2013
(86) PCT No.: PCT/JP2013/058250

§ 371 Date: Sep. 19, 2014

(30) Foreign Application Priority Data
Mar. 29, 2012 (JP) 2012-076919

(51) Int. Cl. H01B 1/02; H01B 1/22

(52) U.S. Cl. CPC H01B 1/02; H01B 1/22
USPC 174/126.2; 156/327; 428/570; 252/513

(57) ABSTRACT

An electroconductive particle including an electroconductive layer made of copper or a copper alloy, or silver or a silver alloy, and a surface layer made of nickel or a nickel alloy and formed on the electroconductive layer is used. By use of the electroconductive particle obtained such that a surface is coated with hard nickel, and an inner side of a nickel layer is copper or silver having low specific resistance, low resistance and high reliability can be obtained. An electroconductive particle having low resistance and high reliability, a circuit connecting material containing electroconductive particles, a mounting body using a circuit connecting material, and a method for manufacturing a mounting body are provided.

### TECHNICAL FIELD

The present invention relates to electroconductive particles used for connection between electrodes, a circuit connecting material containing electroconductive particles, a mounting body using a circuit connecting material, and a method for manufacturing a mounting body.

The present application is based upon and claims the benefit of priority from Japanese Patent Application No. 2012-76919, filed on Mar. 29, 2012 in Japan, the entire contents of which are incorporated herein by reference.

### BACKGROUND ART

Circuit connecting materials (for example, anisotropic electroconductive films) in which electroconductive particles are dispersed in a binder resin are used for connection between circuit members, such as connection between a liquid crystal display and a tape carrier package (TCP), connection between a flexible printed circuit (FPC) and a TCP, or connection between an FPC and a printed wiring board (PWB).

Further, in recent years, when a semiconductor silicon chip is mounted on a board, so-called flip-chip mounting is performed, in which the semiconductor silicon chip is faced down and directly mounted on the board without using wire bond for the connection between circuit members. In the flip-chip mounting, the circuit connecting materials are used for the connection between circuit members.

For the circuit connecting materials in which electroconductive particles are dispersed in a binder resin, the electroconductive particles are actively developed for a decrease in resistance and high connection reliability.

For example, Patent Literature 1 discloses an electroconductive particle obtained such that silver plating is applied to a surface of a resin particle, and gold plating is applied to the silver-plated particle. Further, Patent Literature 2 discloses an electroconductive particle obtained such that a nickel layer is included on a surface of a resin particle, and a surface layer made of silver or copper and having protrusions is formed on the nickel layer. Further, Patent Literature 3 discloses an electroconductive particle obtained such that nickel plating is applied to a surface of a resin particle, and a surface layer made of a nickel-palladium alloy layer and having protrusions is formed on the nickel-plated particle.

Table 1 illustrates specific resistance and Mohs hardness of principal metals used for electronic devices.

TABLE 1

| | Ni | Au | Pd | Cu | Ag |
|---|---|---|---|---|---|
| Specific resistance (μΩ) | 6.84 | 2.35 | 10.7 | 1.67 | 1.62 |
| Mohs hardness | 3.8 | 2.5-3.0 | 4.7 | 3 | 2.5 |

As illustrated in Table 1, gold and silver are soft and thereby when gold or silver is used for a surface layer, as disclosed in Patent Literatures 1 and 2, the particle cannot break through a surface oxide film of a terminal to be connected, and connection resistance values become large. Further, nickel is hard and hence when nickel is used for a surface layer as disclosed in Patent Literature 3, the particle can break through a surface oxide film of a terminal to be connected but specific resistance is high, and thus a connection resistance value becomes large.

### CITATION LIST

### Patent Literature

Patent Literature 1: JP 2002-270038 A

Patent Literature 2: JP 2009-32397 A

Patent Literature 3: JP 2010-27569 A

### SUMMARY OF INVENTION

### Technical Problem

The present invention has been proposed in view of the foregoing, and provides an electroconductive particle having low resistance and high reliability, a circuit connecting material containing electroconductive particles, a mounting body using a circuit connecting material, and a method for manufacturing a mounting body.

### Solution to Problem

As a result of diligent examination, the inventors of the present application have found out that low resistance and high reliability can be obtained by using an electroconductive particle whose surface is coated with hard nickel and copper or silver having low specific resistance is used in an inner side of the nickel layer.

That is, an electroconductive particle according to the present invention includes: an electroconductive layer made of copper or a copper alloy, or silver or a silver alloy; and a surface layer made of nickel or a nickel alloy, and formed on the electroconductive layer.

Further, a circuit connecting material according to the present invention includes a binder resin, and electroconductive particles dispersed in the binder resin, wherein the electroconductive particle includes an electroconductive layer made of copper or a copper alloy, or silver or a silver alloy, and a surface layer made of nickel or a nickel alloy and formed on the electroconductive layer.

Further, a mounting body according to the present invention includes: a first electronic part and a second electronic part being electrically connected by an electroconductive particle including an electroconductive layer made of copper or a copper alloy, or silver or a silver alloy, and a surface layer made of nickel or a nickel alloy, and formed on the electroconductive layer.

Further, a method for manufacturing a mounting body according to the present invention includes: bonding, on a terminal of a first electronic part, a circuit connecting material in which electroconductive particles are dispersed in a binder resin, the electroconductive particle including an electroconductive layer made of copper or a copper alloy, or silver or a silver alloy, and a surface layer made of nickel or a nickel alloy, and formed on the electroconductive layer; temporarily arranging a second electronic part on the circuit connecting material; and pressing the second electronic part with a heating pressing device to connect the terminal of the first electronic part and a terminal of the second electronic part.

According to the present invention, low resistance and high reliability can be obtained by using an electroconductive particle whose surface is coated with hard nickel and copper or silver having low specific resistance is used in an inner side of the nickel layer.

### BRIEF DESCRIPTION OF DRAWINGS

FIG. 1 is a cross sectional view illustrating an electroconductive particle to which the present invention is applied.

FIG. 2 is a cross sectional view illustrating a circuit connecting material in the present embodiment.

FIG. 3 is a cross sectional view illustrating a mounting body in the present embodiment.

FIG. 4 is a cross sectional view illustrating an electroconductive particle in a comparative example.

FIG. 5 is a perspective view for describing evaluation and measurement of current resistance of a mounting body.

FIG. 6 is a perspective view for describing evaluation and measurement of corrosion resistance of a mounting body.

### DESCRIPTION OF EMBODIMENTS

Hereinafter, embodiments of the present invention will be described in detail in the following order with reference to the drawings.

### 1. Electroconductive Particle

### 2. Circuit Connecting Material

### 3. Mounting Body and Method for Manufacturing Mounting Body

### 4. Examples

### 1. ELECTROCONDUCTIVE PARTICLE

An electroconductive particle according to the present invention includes an electroconductive layer made of copper or a copper alloy, or silver or a silver alloy, and a surface layer made of nickel or a nickel alloy formed on the electroconductive layer. The electroconductive layer may be a metal core particle made of copper or a copper alloy, or silver or a silver alloy, or may be a coated layer obtained such that a surface of another metal core particle or a resin core particle is coated.

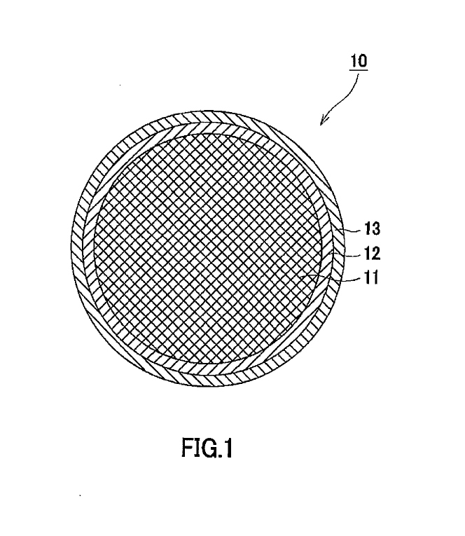

FIG. 1 is a cross sectional view illustrating an example of an electroconductive particle to which the present invention is applied. An electroconductive particle 10 includes a resin particle 11, an electroconductive layer 12 made of copper or a copper alloy, or silver or a silver alloy, and a surface layer 13 made of nickel or a nickel alloy and coating the electroconductive layer 12.

The resin particle 11 is a parent (core) particle of an electroconductive particle, and one that does not cause change, such as destruction, melting, flow, decomposition, or carbonization, at the time of mounting, is used. Examples of the resin particle 11 include copolymers of monofunctional vinyl compounds represented by (meth)acrylic esters such as ethylene, propylene, and styrene, and polyfunctional vinyl compounds, such as diallyl phthalate, triallyl trimellitate, triallyl cyanurate, divinylbenzene, di(meth)acrylate, and tri(meth)acrylate, a curable polyurethane resin, a cured epoxy resin, a phenolic resin, a benzoguanamin resin, a melamine resin, polyamide, polyimide, a silicone resin, a fluororesin, polyester, a polyphenylene sulfide resin, and polyphenylene ether. A particularly desirable resin particle 11 is a polystyrene resin, an acrylic acid ester resin, a benzoguanamine resin, or a copolymer of a monofunctional vinyl compound and a polyfunctional vinyl compound, which is selected according to physical properties, such as the elastic modulus at the time of thermal pressure bonding and breaking strength.

An average particle diameter of the resin particles 11 is not particularly limited but favorably 1 to 20 μm. If the average particle diameter is less than 1 μm, for example, the particles are easily aggregated when being applied non-electrolytic plating, and are less likely to become single particles. Meanwhile, if the average particle diameter exceeds 20 μm, the particles may exceed a range that can be used as an anisotropic electroconductive material for a fine-pitch printed circuit. Note that the average particle diameter of the resin particles is obtained such that the particle diameters of randomly selected 50 base fine particles are measured and the measured particle diameters are arithmetically averaged.

The electroconductive layer 12 is a metal layer made of copper or a copper alloy, or silver or a silver alloy coated by non-electrolytic plating, for example. Regarding the copper or the copper alloy, or the silver or the silver alloy, the purity of copper or silver is favorably 90% or more, and more favorably 95% or more. As for the copper alloy, a Cu—Ni alloy, a Cu—Ag alloy, or the like can be used, for example. Further, regarding the silver alloy, an Ag—Bi alloy, or the like can be used.

Further, the thickness of the electroconductive layer 12 is favorably 0.05 μm or more, and more favorably 0.10 μm or more. If the thickness is less than 0.05 μm, the resistance value of the electroconductive particle 10 becomes large.

The surface layer 13 is a metal layer made of nickel or a nickel alloy coated by non-electrolytic plating or a sputtering method, for example. Regarding the nickel or the nickel alloy, the purity of nickel is favorably 90% or more, and more favorably 95% or more. As the nickel alloy, an Ni—P alloy, an Ni—B alloy, an Ni—Pd alloy, an Ni—Co alloy, or the like can be used, for example.

Further, the thickness of the surface layer 13 is favorably from 0.10 to 0.20 μm, both inclusive. If the thickness is less than 0.10 μm, hardness cannot be obtained, and favorable reliability cannot be obtained. Further, the corrosion resistance is decreased. Meanwhile, if the thickness exceeds 0.2 μm, the resistance value of the electroconductive particle 10 becomes large.

Further, the surface layer 13 favorably includes protrusions on the surface. With the protrusions, the particle can break through an oxide film formed on a surface of an electrode, and can decrease the resistance value and improve the reliability. An example of a method for forming the protrusions includes, when forming a nickel film by non-electrolytic plating, depositing the nickel film and fine particles that are to serve as cores of the protrusions at the same time, and forming the nickel film while taking in the fine particles. Further, examples of the fine particle include nickel, palladium, cobalt, and chrome.

Since the electroconductive particle 10 uses the resin particle 11 as a parent particle, and the electroconductive particle 10 has narrower particle distribution than metal particles, and can be used for fine-pitch wiring. Further, the surface of the resin particle 11 is coated with the electroconductive layer 12 made of copper or a copper alloy, or silver or a silver alloy. Therefore, the conductivity of the electroconductive particle 10 can be improved. Further, the surface layer 13 made of nickel or a nickel alloy is formed on the electroconductive layer 12. Therefore, the electroconductive particle 10 can be cut into wiring, and high reliability can be obtained with respect to metal wiring that easily forms an oxide film. Further, high reliability can be obtained with respect to a fine-pitch wiring member having a smooth surface, such as an indium zinc oxide (IZO) or an amorphous indium tin oxide (ITO). Further, the surface layer 13 made of nickel or a nickel alloy is formed on the electroconductive layer 12 made of copper or a copper alloy, or silver or a silver alloy. Therefore, a decrease in conductivity performance in a storage environment due to oxidation/sulfidation is prevented, and corrosion/migration in a use environment (voltage application environment) can be prevented.

### 2. CIRCUIT CONNECTING MATERIAL

The circuit connecting material in the present embodiment includes a binder resin, and electroconductive particles dispersed in the binder resin, and the electroconductive particle includes an electroconductive layer made of copper or a copper alloy, or silver or a silver alloy, and a surface layer made of nickel or a nickel alloy formed on the electroconductive layer. The binder resin is not especially limited but more favorably contains a film-forming resin, a polymerizable resin, a curing agent, and a silane coupling agent.

The film-forming resin corresponds to a high-molecular weight resin having an average molecular weight of 10,000 or more, and favorably has the average molecular weight of about 10,000 to 80,000 in terms of film forming property. As the film-forming resin, various resins, such as an epoxy resin, a modified epoxy resin, a urethane resin, and a phenoxy resin, can be used. Among them, a phenoxy resin is favorably used in terms of a film-forming state, connection reliability, and the like.

As the polymerizable resin, a compound having polymerizability, such as an epoxy resin or an acrylic resin, can be appropriately used.

As the epoxy resin, a commercially available epoxy resin can be used with no specific limitation. As the epoxy resin, to be specific, a naphthalene type epoxy resin, a biphenyl type epoxy resin, a phenol novolac type epoxy resin, a bisphenol type epoxy resin, a stilbene type epoxy resin, a triphenol methane type epoxy resin, a phenol aralkyl type epoxy resin, a naphthol type epoxy resin, a dicyclopentadiene type epoxy resin, or a triphenylmethane type epoxy resin can be used. These resins may be independently used, and two or more of the resins may be combined. Furthermore, the resins may be arbitrarily combined with another organic resin, such as an acrylic resin.

As the acrylic resin, monofunctional (meth)acrylate, or bifunctional or more polyfunctional (meth)acrylate can be used with no specific limitation. Examples of the monofunctional (meth)acrylate include methyl(meth)acrylate, ethyl(meth)acrylate, n-propyl(meth)acrylate, i-propyl(meth)acrylate, and n-butyl(meth)acrylate. Examples of the bifunctional or more polyfunctional (meth)acrylate includes bisphenol F-EO modified di(meth)acrylate, bisphenol A-EO modified di(meth)acrylate, trimethylolpropane PO modified (meth)acrylate, and polyfunctional urethane (meth)acrylate. These types of (meth)acrylate may be independently used, or two or more types of the (meth)acrylate may be combined.

The curing agent can be appropriately selected depending on the intended purpose with no specific limitation. For example, a latent curing agent activated by heating, a latent curing agent generating free radicals by heating, or the like can be used. When an epoxy resin is used as the polymerizable resin, a latent curing agent made of imidazoles, amines, a sulfonium salt, an onium salt, and the like is used. Further, as the curing agent of when an acrylic resin is used as the polymerizable resin, a thermal radical generating agent of organic peroxide can be favorably used. Examples of the organic peroxide include benzoyl peroxide, lauroyl peroxide, butyl peroxide, benzyl peroxide, dilauroyl peroxide, dibutyl peroxide and peroxydicarbonate.

As the silane coupling agent, an epoxy-based, an amino-based, a mercapto-sulfide based, or an ureido-based silane can be used. Among them, an epoxy-based silane coupling agent is favorably used in the present embodiment. Accordingly, adhesiveness in an interface between the organic material and the inorganic material can be improved.

Further, as another additive composition, it is favorable to contain an inorganic filler. By containing the inorganic filler, fluidity of the resin layer at the time of pressure bonding is adjusted, and a particle capturing rate can be improved. As the inorganic filler, silica, talc, titanium oxide, calcium carbonate, magnesium oxide, or the like can be used.

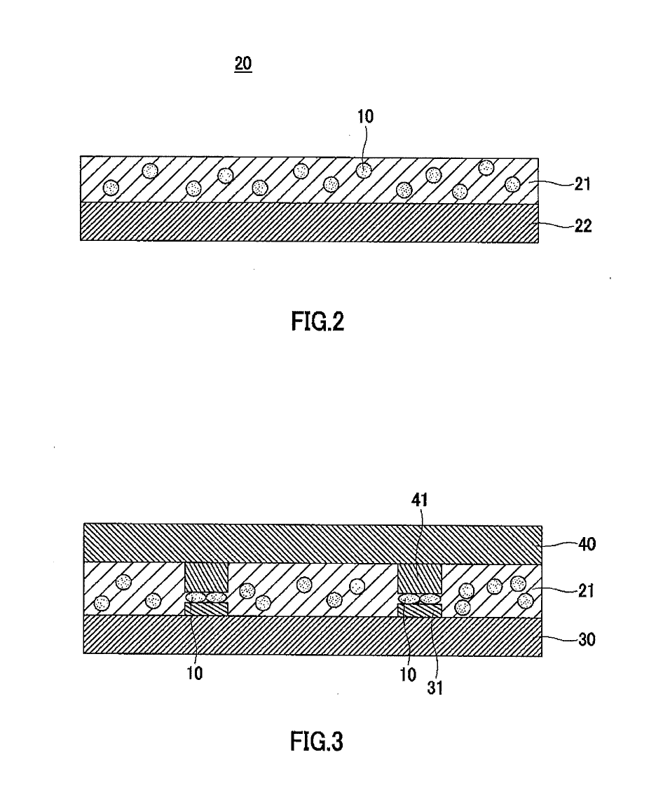

Next, a method for manufacturing the above-described circuit connecting material including the electroconductive particles will be described with reference to FIG. 2. The method for manufacturing the circuit connecting material in the present embodiment includes an application process of applying a composition of a binder resin 21 in which the electroconductive particles 10 are dispersed on a release substrate 22, and a dry process of drying the composition on the release substrate 22.

In the application process, after the composition is combined and adjusted by using an organic solvent, the composition is applied on the release substrate by using a bar coater, an application device, or the like.

As the organic solvent, toluene, ethyl acetate, a mixed solvent thereof, or other various organic solvents can be used. Further, the release substrate 22 is made of a layered structure in which a release agent, such as silicone, is applied on a poly ethylene terephthalate (PET), oriented polypropylene (OPP), poly-4-methylpentene-1 (PMP), or polytetrafluoroethylene (PTFE), and maintains a film shape of the composition.

In the next dry process, the composition on the release substrate 22 is dried with a heating oven, a heating drying device, or the like. Accordingly, an electroconductive adhesive film in which the circuit connecting material is formed in a film state can be obtained.

### 3. MOUNTING BODY AND METHOD FOR MANUFACTURING MOUNTING BODY

FIG. 3 is a cross sectional view illustrating a mounting body in the present embodiment. The mounting body in the present embodiment is formed such that a first electronic part 30 and a second electronic part 40 are electrically connected by the electroconductive particles 10, the electroconductive particle including the electroconductive layer made of copper or a copper alloy, or silver or a silver alloy, and the surface layer made of nickel or a nickel alloy and formed on the electroconductive layer.

An example of the first electronic part 30 includes a wiring member including a fine-pitch terminal 31 having a smooth surface, such as indium zinc oxide (IZO) or amorphous indium tin oxide (ITO). Further, an example of the second electronic part 40 includes an integrated circuit (IC) on which a terminal 41, such as a fine-pitch bump, is formed.

The mounting body in the present embodiment is connected by the above-described electroconductive particles. Therefore, low resistance and highly reliable connection can be obtained, and superior current resistance, storage stability, and corrosion resistance can be obtained.

Next, a method for manufacturing the mounting body using the above-described circuit connecting material will be described. The method for manufacturing the mounting body in the present embodiment includes: bonding, on the terminal 31 of the first electronic part 30, the circuit connecting material in which the electroconductive particles 10 are dispersed in the binder resin 21, the electroconductive particle including the electroconductive layer made of copper or a copper alloy, or silver or a silver alloy, and the surface layer made of nickel or a nickel alloy, and formed on the electroconductive layer; temporarily arranging the second electronic part 40 on the circuit connecting material; pressing the second electronic part 40 with a heating pressing device to connect the terminal 31 of the first electronic part and the terminal 41 of the second electronic part.

Accordingly, the mounting body in which the terminal 31 of the first electronic part 30 and the terminal 41 of the second electronic part 40 are connected through the electroconductive particles 10 is obtained.

In the method for manufacturing the mounting body in the present embodiment, the electroconductive particles having the surface layer made of nickel or a nickel alloy are contained in the circuit connecting material. Therefore, the electroconductive particles can cut into metal wiring that easily forms an oxide film, and high reliability can be obtained. Further, the high reliability can be obtained even when a wiring material including a fine-pitch terminal having a smooth surface, such as indium zinc oxide (IZO) or amorphous indium tin oxide (ITO), is used.

### 4. EXAMPLES

Hereinafter, examples of the present invention will be described. However, the present invention is not limited to the examples.

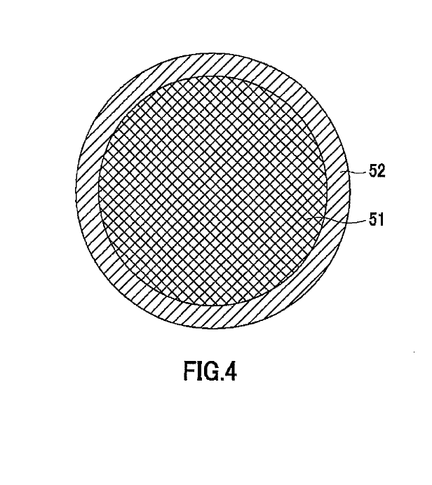

As illustrated in FIG. 1, the electroconductive particles 10 of Examples 1 to 9, in which the electroconductive layer 12 and the surface layer 13 are formed on the resin particle 11 in this order, were prepared. Further, as illustrated in FIG. 4, electroconductive particles of Comparative Examples 1 to 3, in which a surface layer 52 is formed on a resin particle 51 were prepared, as a conventional technology. Further, regarding the electroconductive particles, the thickness of the electroconductive layers and the thickness of the surface layers were measured.

Next, anisotropic electroconductive films were prepared by using the electroconductive particles of Examples 1 to 9 and Comparative Examples 1 to 3 as the circuit connecting materials. Then, mounting bodies for connection resistance evaluation, reliability evaluation, current resistance evaluation, and corrosion resistance evaluation were prepared by using the anisotropic electroconductive films.

The measurement of the thickness of the electroconductive layers and the surface layers, the preparation of the anisotropic electroconductive films and the mounting bodies, and each evaluation were performed as follows.

### [Measurement of Thickness of Electroconductive Layers and Surface Layers]

The electroconductive particles are dispersed in an epoxy adhesive and cured, and cross sections of the particles were cut out with a grinder (manufactured by Marumoto Struers K.K.). The cross sections of the particles were observed with a scanning electron microscope (SEM) (VE-8800, manufactured by Keyence Corporation), and the thickness of the electroconductive layers and the thickness of the surface layers were measured.

[Preparation of Anisotropic electroconductive Films]

The electroconductive particles of Examples and Comparative Examples were dispersed in a thermosetting binder resin containing 50 parts of a microcapsule type amine-based curing agent (product name: Novacure HX3941HP, manufactured by Asahi Chemical Corporation), 14 parts of a liquid epoxy resin (product name: EP828, manufactured by Japan Epoxy Resin Co., Ltd.), 35 parts of a phenoxy resin (product name: YP50, manufactured by Toto Kasei Co., Ltd.), and 1 part of a silane coupling agent (product name: KBE403, manufactured by Shin-Etsu Chemical Co., Ltd.) to thereby have the volume ratio of 10%. The adhesive composition was applied on a silicone-treated release PET film to have the thickness of 35 μm to thereby prepare a sheet anisotropic electroconductive film.

### [Preparation of Mounting Bodies for Connection Resistance Evaluation, Reliability Evaluation, and Current Resistance Evaluation]

Connection of a COF (base material for evaluation, 200 μm-pitched, Cu (8 μm-thick)-Sn plated, 38 μm-thick S'perflex base material) and a PWB (base material for evaluation, 200 μmP, Cu (35 μm-thick)-Au plated, FR-4 base material) was conducted using the anisotropic electroconductive films. First, the anisotropic electroconductive film slit into a width of 2.0 mm was bonded to the PWB (condition: 80° C., 1 Mpa, 1 sec), followed by positioning and placing the COF thereon. The resulting laminate was bonded by pressure bonding using a 250 μm-thick silicon rubber as a buffer material and a heating tool having a width of 2.0 mm, in the pressure bonding condition of 190° C., 3 Mpa, 10 seconds, to thereby produce a mounting body.

### [Preparation of Mounting Body for Corrosion Resistance Evaluation]

Connection of a COF (base material for evaluation, 50 μm-pitched, Cu (8 μm-thick)-Sn plated, 38 μm-thick S'perflex base material) and non-alkali glass (base material for evaluation, 0.7 mm-thick) was conducted. First, the anisotropic electroconductive film slit into a width of 2.0 mm was bonded to the non-alkali glass (condition: 80° C., 1 Mpa, 1 sec), followed by positioning and placing the COF thereon. The resulting laminate was bonded by pressure bonding using a 250 μm-thick silicon rubber as a buffer material and a heating tool having a width of 2.0 mm, in the pressure bonding condition of 190° C., 3 Mpa, 10 seconds, to thereby produce a mounting body.

### [Evaluation of Connection Resistance and Reliability]

Conduction resistance values of the mounting bodies of when a 1 mA current was applied were measured by a 4-terminal method using a digital multimeter (commodity number: Digital Multimeter 7555, manufactured by Yokogawa Electric Corporation).

The connection resistance was evaluated by using initial conduction resistance. Evaluation was performed such that the conduction resistance of 0.2Ω or less was ◯, the conduction resistance of from 0.2 to 0.5Ω (both exclusive) was Δ, and the conduction resistance of 0.5Ω or more was x.

Further, the reliability was evaluated using the conduction resistance values after a thermal humidity (TH) test of the temperature of 85° C., the humidity of 85% RH, and 500 hours. The evaluation was performed such that the conduction resistance of 0.2Ω or less was ◯, the conduction resistance of from 0.2 to 0.5Ω (both exclusive) was Δ, and the conduction resistance of 0.5Ω or more was x.

### [Evaluation of Current Resistance]

As illustrated in FIG. 5, V-I measurement was performed with respect to the mounting bodies, and evaluation of current characteristics was performed. In the mounting body, a PWB conductor pattern 62 formed on a PWB 61 and a COF conductor pattern 64 formed on a COF were connected through an anisotropic electroconductive film 63. Current was applied between the PWB conductor pattern 62 and the COF conductor pattern 64 at 10 mA/sec, and V-I characteristic evaluation was performed. Current values deviating from a straight line (proportional relationship) were read out and the current resistance was evaluated in the V-I measurement. Evaluation was performed such that the current value of 500 mA or more was ◯, and the current value of from 200 to 500 mA (exclusive of 500 mA) was Δ.

### [Evaluation of Storage Stability]

The electroconductive particles were put in small bottles, and left for one month in a normal temperature environment in an open state. Color change states of the electroconductive particles were confirmed by visual check. Evaluation was performed such that the electroconductive particle having no color change was ◯, and the electroconductive particle having color change was x.

### [Evaluation of Corrosion Resistance]

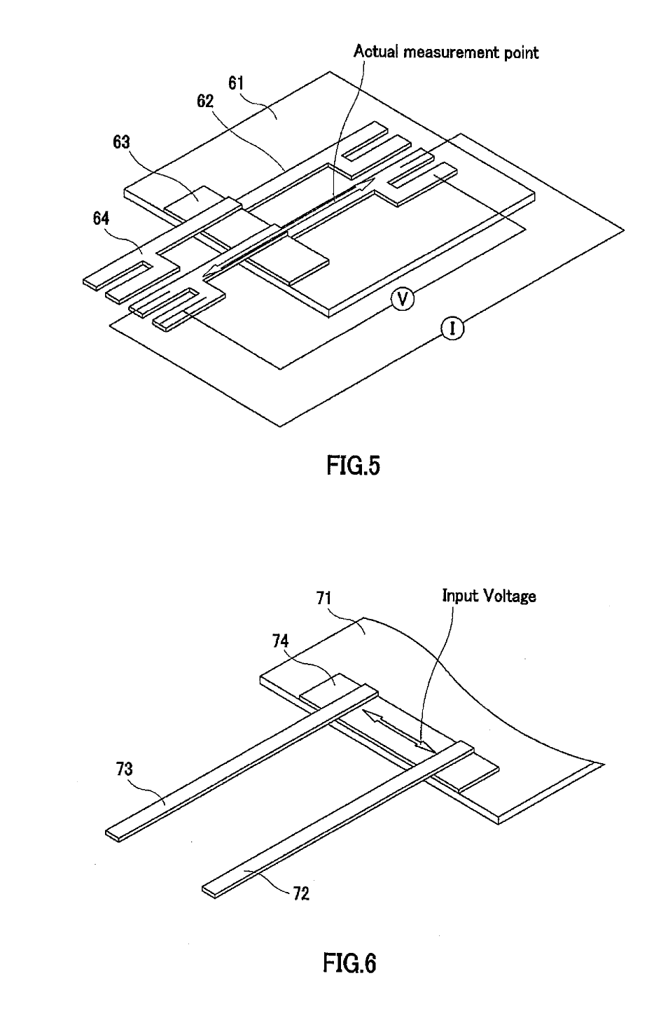

As illustrated in FIG. 6, in a mounting body in which non-alkali glass 71 and a COF are bonded with an anisotropic electroconductive film 74, a voltage DC 50 V was applied to adjacent COF terminals 72 and 73, and an environment test was performed in an oven at the temperature of 60° C., and the humidity of 95%. Corrosion (migration) was confirmed with a microscope after 500 hours. Evaluation was performed such that the mounting body having no migration was ◯, and the mounting body having migration was x.

### Example 1

Ag plating was applied to a surface of a resin core as an electroconductive layer and Ni plating as a surface layer was applied thereon, to thereby prepare an electroconductive particle. The thickness of the electroconductive layer was 0.10 μm, and the thickness of the surface layer was 0.10 μm. An anisotropic electroconductive film containing the electroconductive particles was prepared, and a mounting body was further manufactured using the anisotropic electroconductive film. The connection resistance, reliability, current resistance, storage stability, and corrosion resistance were evaluated.

Table 2 illustrates evaluation results of Example 1. The connection resistance was ◯, the reliability was ◯, the current resistance was ◯, the storage stability was ◯, and the corrosion resistance was ◯.

### Example 2

An electroconductive particle was prepared similarly to Example 1 except that the thickness of an electroconductive layer was 0.15 and evaluation was performed.

Table 2 illustrates evaluation results of Example 2. The connection resistance was ◯, the reliability was ◯, the current resistance was ◯, the storage stability was ◯, and the corrosion resistance was ◯.

### Example 3

An electroconductive particle was prepared similarly to Example 1 except that the thickness of an electroconductive layer was 0.20 μm, and evaluation was performed.

Table 2 illustrates evaluation results of Example 3. The connection resistance was ◯, the reliability was ◯, the current resistance was ◯, the storage stability was ◯, and the corrosion resistance was ◯.

### Example 4

An electroconductive particle was prepared similarly to Example 1 except that Cu plating was applied as an electroconductive layer, and the thickness of the electroconductive layer was 0.07 μm, and evaluation was performed.

Table 2 illustrates evaluation results of Example 4. The connection resistance was ◯, the reliability was Δ, the current resistance was ◯, the storage stability was ◯, and the corrosion resistance was ◯.

### Example 5

An electroconductive particle was prepared similarly to Example 1 except that Cu plating was applied as an electroconductive layer, and the thickness of the electroconductive layer was 0.10 μm, and evaluation was performed.

Table 2 illustrates evaluation results of Example 5. The connection resistance was ◯, the reliability was ◯, the current resistance was ◯, the storage stability was ◯, and the corrosion resistance was ◯.

### Example 6

An electroconductive particle was prepared similarly to Example 1 except that Cu plating was applied as an electroconductive layer, and the thickness of the electroconductive layer was 0.15 μm, and evaluation was performed.

Table 2 illustrates evaluation results of Example 6. The connection resistance was ◯, the reliability was ◯, the current resistance was ◯, the storage stability was ◯, and the corrosion resistance was ◯.

### Example 7

An electroconductive particle was prepared similarly to Example 1 except that Cu plating was applied as an electroconductive layer, and the thickness of the electroconductive layer was 0.20 μm, and evaluation was performed.

Table 2 illustrates evaluation results of Example 7. The connection resistance was ◯, the reliability was ◯, the current resistance was ◯, the storage stability was ◯, and the corrosion resistance was ◯.

### Example 8

An electroconductive particle was prepared similarly to Example 1 except that Cu plating was applied as an electroconductive layer, the thickness of an electroconductive layer was 0.10 μm, and the thickness of a surface layer was 0.20 μm, and evaluation was performed.

Table 2 illustrates evaluation results of Example 8. The connection resistance was ◯, the reliability was Δ, the current resistance was ◯, the storage stability was ◯, and the corrosion resistance was ◯.

### Example 9

An electroconductive particle was prepared similarly to Example 1 except that Cu plating was applied as an electroconductive layer, and protrusions were formed on a surface layer, and evaluation was performed.

Table 2 illustrates evaluation results of Example 9. The connection resistance was ◯, the reliability was ◯, the current resistance was ◯, the storage stability was ◯, and the corrosion resistance was ◯.

### Comparative Example 1

Evaluation was performed similarly to Example 1 except that Ag plating with the thickness of 0.10 μm was applied on a surface of a resin core as a surface layer, and an electroconductive particle was prepared.

Table 2 illustrates evaluation results of Comparative Example 1. The connection resistance was ◯, the reliability was ◯, the current resistance was ◯, the storage stability was x, and the corrosion resistance was x.

### Comparative Example 2

Evaluation was performed similarly to Example 1 except that Cu plating with the thickness of 0.10 μm was applied on a surface of a resin core as a surface layer, and an electroconductive particle was prepared.

Table 2 illustrates evaluation results of Comparative Example 2. The connection resistance was ◯, the reliability was ◯, the current resistance was ◯, the storage stability was x, and the corrosion resistance was x.

### Comparative Example 3

Evaluation was performed similarly to Example 1 except that Ni plating with the thickness of 0.10 μm was applied on a surface of a resin core as a surface layer, and an electroconductive particle was prepared.

Table 2 illustrates evaluation results of Comparative Example 3. The connection resistance was x to Δ, the reliability was x, the current resistance was Δ, the storage stability was ◯, and the corrosion resistance was ◯.

TABLE 2

| | Example | Example | Example | Example | Example | Example | Example | Example | Example | Comparative | Comparative | Comparative |
|---|---|---|---|---|---|---|---|---|---|---|---|---|
| | 1 | 2 | 3 | 4 | 5 | 6 | 7 | 8 | 9 | Example 1 | Example 2 | Example 3 |
| Core particle | Resin | Resin | Resin | Resin | Resin | Resin | Resin | Resin | Resin | Resin | Resin | Resin |
| Electro- | Ag | Ag | Ag | Cu | Cu | Cu | Cu | Cu | Cu | — | — | — |
| conductive | | | | | | | | | | | | |
| layer | | | | | | | | | | | | |
| Electro- | 0.10 | 0.15 | 0.20 | 0.07 | 0.10 | 0.15 | 0.20 | 0.10 | 0.10 | — | — | — |
| conductive | | | | | | | | | | | | |
| layer | | | | | | | | | | | | |
| thickness | | | | | | | | | | | | |
| (μm) | | | | | | | | | | | | |
| Surface layer | Ni | Ni | Ni | Ni | Ni | Ni | Ni | Ni | Ni | Ag | Cu | Ni |
| | | | | | | | | | (protrusion) | | | |
| Surface layer | 0.10 | 0.10 | 0.10 | 0.10 | 0.10 | 0.10 | 0.10 | 0.20 | 0.10 | 0.10 | 0.10 | 0.10 |
| thickness | | | | | | | | | | | | |
| (μm) | | | | | | | | | | | | |
| Connection | ∘ | ∘ | ∘ | ∘ | ∘ | ∘ | ∘ | ∘ | ∘ | ∘ | ∘ | x-Δ |
| resistance | | | | | | | | | | | | |
| Reliability | ∘ | ∘ | ∘ | Δ | ∘ | ∘ | ∘ | Δ | ∘ | ∘ | ∘ | x |
| Current | ∘ | ∘ | ∘ | ∘ | ∘ | ∘ | ∘ | ∘ | ∘ | ∘ | ∘ | Δ |
| resistance | | | | | | | | | | | | |
| Storage | ∘ | ∘ | ∘ | ∘ | ∘ | ∘ | ∘ | ∘ | ∘ | x | x | ∘ |
| stability | | | | | | | | | | | | |
| Corrosion | ∘ | ∘ | ∘ | ∘ | ∘ | ∘ | ∘ | ∘ | ∘ | x | x | ∘ |
| resistance | | | | | | | | | | | | |

As shown in Comparative Examples 1 and 2, when an electroconductive layer was not formed and an electroconductive particle having only an Ag or Cu surface layer was used, results of poor storage stability and corrosion resistance were obtained. Comparative Example 3 was an electroconductive particle, in which an electroconductive layer was not formed and only the Ni surface layer was formed. Therefore a result was obtained that storage stability and corrosion resistance were favorable while connection resistance, reliability and current resistance were slightly poor.

As shown in Examples 1 to 9, when an electroconductive particle having an electroconductive layer made of Ag or Cu, and a surface layer made of Ni was used, the storage stability and the corrosion resistance were improved, low resistance and high reliability connection was obtained, and excellent current resistance, storage stability, and corrosion resistance were obtained.

### REFERENCE SIGNS LIST

10 Electroconductive particle
11 Resin particle
12 Electroconductive layer
13 Surface layer
20 Circuit connecting material
21 Binder resin
22 Release substrate
30 First electronic part
31 Terminal
40 Second electronic part
41 Terminal
51 Resin particle
52 Surface layer
61 PWB
62 PWB conductor pattern
63 Anisotropic electroconductive film
64 COF conductor pattern
71 Non-alkali glass
72 and 73 COF terminal

1. An electroconductive particle comprising:
an electroconductive layer made of copper or a copper alloy, or silver or a silver alloy; and
a surface layer made of nickel or a nickel alloy, and formed on the electroconductive layer.

2. The electroconductive particle according to claim 1, comprising:
a resin particle,
wherein the electroconductive layer coats a surface of the resin particle.

3. The electroconductive particle according to claim 1, wherein a thickness of the electroconductive layer is 0.10 μm or more.

4. The electroconductive particle according to claim 1, wherein a thickness of the surface layer is from 0.10 to 0.20 μm, both inclusive.

5. The electroconductive particle according to claim 1, wherein the surface layer includes a protrusion.

6. A circuit connecting material comprising:
a binder resin; and
electroconductive particles dispersed in the binder resin,
wherein the electroconductive particle includes an electroconductive layer made of copper or a copper alloy, or silver or a silver alloy, and a surface layer made of nickel or a nickel alloy, and formed on the electroconductive layer.

7. A mounting body comprising:
a first electronic part and a second electronic part being electrically connected by an electroconductive particle including an electroconductive layer made of copper or a copper alloy, or silver or a silver alloy, and a surface layer made of nickel or a nickel alloy, and formed on the electroconductive layer.

8. A method for manufacturing a mounting body, the method comprising:
bonding, on a terminal of a first electronic part, a circuit connecting material in which electroconductive particles are dispersed in a binder resin, the electroconductive particle including an electroconductive layer made of copper or a copper alloy, or silver or a silver alloy, and a surface layer made of nickel or a nickel alloy, and formed on the electroconductive layer;
temporarily arranging a second electronic part on the circuit connecting material; and
pressing the second electronic part with a heating pressing device to connect the terminal of the first electronic part and a terminal of the second electronic part.

9. The electroconductive particle according to claim 2, wherein a thickness of the electroconductive layer is 0.10 μm or more.
